(19) United States
(12) Patent Application Publication
(10) Pub. No.: US 2006/0090965 A1
(43) Pub. Date: May 4, 2006

(54) Grease pressure release gun

(75) Inventors: Rodger Lake, Cardiff (AU); Terrence Sarginson, Cardiff (AU)

Correspondence Address: MICHAEL MOLINS;MOLINS & CO., SUITE S, LEVEL 6, 139 MACQUARIE ST, SYDNEY NSW, 2000, AU

(73) Assignee: Customer Fluidpower Pty Limited

(21) Appl. No.: 11/179,536

(22) Filed: Jul. 13, 2005

(30) Foreign Application Priority Data
Nov. 2, 2004 (AU) 2004100935

(51) Int. Cl. F16N 21/00

(52) U.S. Cl. 184/105.2

(57) ABSTRACT

A tool for visually detecting and releasing grease overpressure from a grease nipple comprises a grease coupling in which is formed a vent opening. The grease coupling is carried by an extension tube that extends rearward towards an insert to which it is connected. The insert has a bore in which reciprocates a button bolt. The button bolt extends past a rear face of the insert to an indicator button. A piston extends through the extension tube, from the area of the vent to the button bolt. Grease entering the coupling may exit the vent and may push the piston so as to move the indicator button thus indicating potentially dangerous overpressure.

### FIELD OF THE INVENTION

The invention pertains to lubrication and maintenance and more particularly to a tool that is used to safely check for grease overpressure and to relieve grease overpressure from a grease nipple if overpressure is present.

### BACKGROUND OF THE INVENTION

A wide variety of machines with moving parts utilise grease for lubrication. Grease may be introduced, extracted or replenished through a grease nipple. A common grease nipple is, in essence, a check valve that allows grease to be introduced, but only released or expelled when the nipple's spring loaded ball valve is disabled by depressing it. Unfortunately, grease pressure can accumulate behind the grease nipple in a way that can cause the nipple to be ejected under force, potentially injuring a person changing the grease nipple or persons nearby. Forces of up to 500 N may be developed in grease systems, sometimes pressurised in the region of 48 Mega Pascals. Serious injuries are known to have occurred as a result the removal of grease nipples from pressurised systems. The applicant is not aware of any device on the market that will give the maintenance person an indication as to the grease pressure behind a particular nipple, particularly where the overpressure is low or the grease volume is low.

### OBJECTS AND SUMMARY OF THE INVENTION

It is an object of the invention to provide a safety device that allows the grease pressure behind the grease nipple to be monitored, and relieved in a safe fashion.

It is another object of the invention to provide a device that may be used by either left or right-handed people.

It is another object of the invention to provide a small and relatively simple hand held device which can be used to monitor or detect grease pressure as well as relieve grease pressure in order that a nipple may be safely removed.

Accordingly, there is provided a tool having a ventable grease coupling, an extension tube and an indicator such as a brightly coloured button. An elongated rod or piston extends from the vent to the indicator, within the length of the extension tube. When the coupling is attached to a grease nipple, any grease under pressure from behind the nipple is able to exit the vent. In doing so, escaping grease displaces the piston. Displacement of the piston causes the indicator to move.

### BRIEF DESCRIPTION OF THE DRAWING FIGURES

In order that the invention be better understood, examples, of one or more preferred embodiments will now be described with reference to the following drawing figures:

FIG. 1 is a side elevation of a grease pressure monitoring and relief tool, with a pistol style grip;

FIG. 2 is a cross section of the insert formed into the handle of the grip depicted in FIG. 1;

FIG. 3 is a side elevation of a reciprocating button bolt, depicted in FIG. 1;

FIG. 4 is an exploded side elevation of a grease coupling incorporating a vent;

FIG. 5 is a side elevation of an extension tube; and

FIG. 6 is a side elevation of an elongated piston that reciprocates within the tube depicted in FIG. 5 and FIG. 1.

### BEST MODE AND OTHER EMBODIMENTS OF THE INVENTION

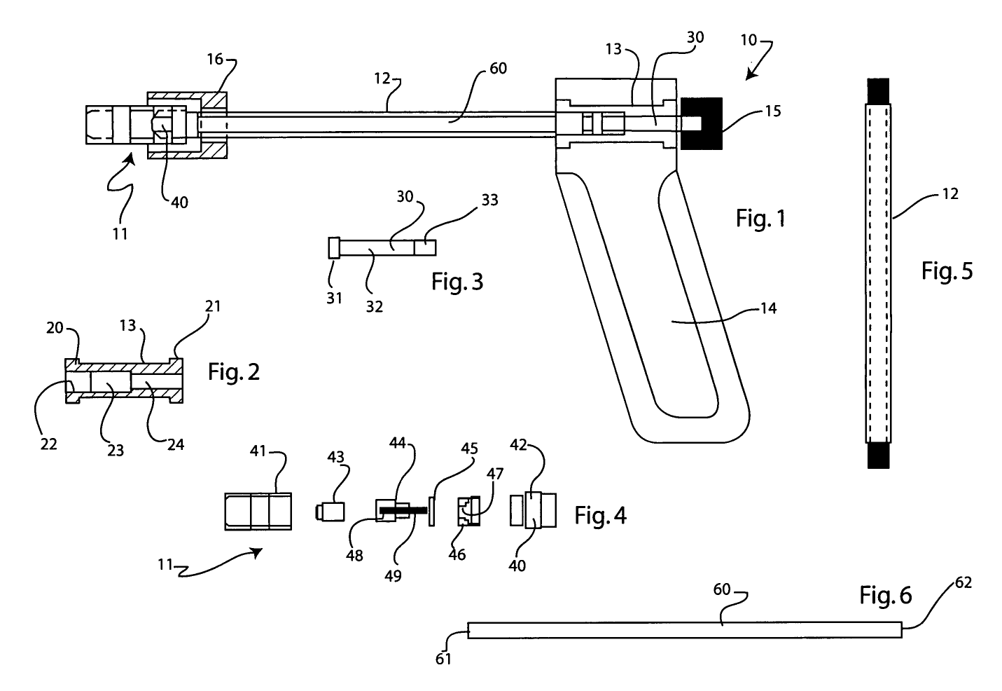

As shown in FIG. 1, a tool for detecting and relieving excess grease pressure 10 comprises a grease coupling assembly 11 that is in communication with an elongated extension tube 12. The front end of the tube 12 screws into the grease coupling 11 and the rear end of the tube screws into or is otherwise attached to an insert 13. The insert 13 may be moulded into or otherwise retained by a pistol grip or handle 14. The coupling is associated with a sliding safety shroud 16. As shown in FIG. 1, the safety shroud 16 is carried by the extension shaft 12 so that it can slide forward into a position where it surrounds (as explained below) a vent opening 40. It can be retracted so that the vent 40 can be visually inspected and so that the area around the vent can be cleaned, if required.

As shown in FIG. 2, the insert 13 comprises a brass body that in this example is formed with a forward flange 20 and a rear flange 21. The forward portion of the insert 13 carries a tapered and threaded fitting 22 that receives the rear end of the extension tube 12. The threaded fitting leads into a central bore 23 and the central bore leads to a rear bore 24.

As shown in FIG. 3, a button bolt 30 reciprocates within the insert 13. The button bolt 30 has a slotted head 31, a central shaft 32 and a threaded end 33. The head 31 reciprocates within the central bore 23 of the insert. The threaded end of the button bolt 33 extends through the rear face of the insert and is threaded into the indicator button 15.

As shown in FIG. 4, a modified grease coupling assembly 11 is fitted to the front end of the extension tube 12. The coupling assembly 11 further comprises a forward shroud 41 that screws onto a rear adaptor 42. Relatively conventional coupling components are inserted within the shroud and located between the shroud 41 and the adaptor 42. These components further comprise a plurality of metallic gripping fingers 43, a seat 44, a washer 45 and a resilient rubber or polymer plug 46 having a central bore 47. In this example, the nipple's seat 44 has a hemispherical front surface 48 that seals against the grease nipple. A slotted pin 49 is silver soldered into a central bore of the seat 44. The slotted pin 49 serves to depress the grease nipple's spring loaded ball or check valve. The slotted pin 49 also allows grease to travel past the seat 44 into the area where the vent 40 is. The resilient rubber plug 46 abuts the washer 45 and straddles the seat in a way that allows the rear portions of the gripping fingers 43 to be resiliently biased by the plug 46. It is important to note that the adaptor 42 in addition to the front threads for engaging the shroud 41 and rear threaded opening for receiving the extension tube 12 also contains a small vent or opening about 1 mm diameter 40 that is in fluid communication with the interior of the adaptor 42.

As shown in FIG. 5, the extension tube 12 is formed as a straight hollow tube an e.g. tapered and threaded male connectors at each end.

As shown in FIG. 6, a reciprocating rod or piston 60 extends from a location just forward of the vent 40, through the length of the extension tube 12, so that its rear end 62 abuts the slotted head 31 of the button bolt 30 when the button bolt is in a forwardmost position.

The operation of the device proceeds as follows. Before a grease nipple is serviced, particularly if the grease nipple is to be removed, the device's indicator button 15 is pressed in. This urges the rod or piston 60 into its forwardmost position, the front end of the rod 60 being just forward of the vent 40. Then, the grease coupling assembly 11 of the present invention is engaged over the grease nipple and pressed onto it using the handle 14. Pressure against the grease nipple, causes the slotted pin 49 to depress the grease nipple's ball. Because the front surface 48 of the seat 44 is in contact with the nipple, any grease pressure that has accumulated behind the nipple escapes through the slotted pin 49. The escaping grease thus makes contact with the front surface 61 of the rod or piston 60. The escaping grease will urge the rod or piston 60 rearward. This causes the vent opening 40 to be revealed or uncovered by the rod 60 such that excess grease can escape through the opening 40. Movement of the rod or piston 60 rearward also causes rearward movement of the button bolt 30 and in the indicating button 15. In preferred embodiments, the operator monitors the movement of the indicating button 15 because the vent opening 40 may be obscured by the safety shroud 16. If the indicating button 15 has been displaced fully to the rear, and the operator believes that all the grease pressure has been relieved. He may re-test the nipple by reintroducing the grease coupling after having again depressed the actuating button 15. If the indicating button 15 is fully depressed and the gun is introduced onto the nipple, and the indicating button 15 fails to move, there is no longer a dangerous accumulation of grease pressure on the nipple.

While the present invention has been described with reference to particular details of construction, these should be understood as having been provided by way of example and not as limitations to the scope of spirit or the invention. In particular, the shape and configuration of the handle 14 is merely one example of a tool configuration which is considered ergonomically sensible. The shape or presence of a gun-shaped handle is not considered absolutely essential to the teachings of the invention. Similarly, the particular length of the extension tube 12 can be provided to any length which is convenient for the user.

What is claimed is:

1. A grease pressure release tool, comprising:
a grease coupling in which is formed a vent opening, the coupling carried by an extension tube;
the extension tube being connected to an insert, the insert having a bore in which reciprocates a button bolt;
the button bolt extending past a rear face of the insert to an indicator button; a piston extending through the extension tube, from the area of the vent to the button bolt.

2. The tool of claim 1, wherein:
the tube is threaded at each end.

3. The tool of claim 1, wherein:
the button bolt has an end that extends past a rear surface of the insert, the end carrying an indicator button.

4. The tool of claim 1, wherein:
the insert in inserted into a handle.

5. The tool of claim 4, wherein:
the handle is a grip.

6. The tool of claim 5, wherein:
the grip is a pistol grip.

7. The tool of claim 1, wherein:
the vent is formed in an adapter that connects the tube to the grease coupling.

8. The tool of claim 7, wherein:
the piston extends from an area in the adapter to the button bolt.

9. The tool of claim 1, wherein:
the grease coupling further comprises an internal seat adapted to seal against a grease nipple, the seat having a bore through which grease from the nipple may pass.

10. The tool of claim 1, wherein:
the button bolt has a head that is retained by and reciprocates within the insert.

11. The tool of claim 1, wherein:
the grease coupling is associated with a reciprocating, retractable safety shroud.

12. The tool of claim 11, wherein:
the safety shroud is carried by the tube.

13. The tool of claim 3, wherein:
the grease coupling further comprises an internal seat adapted to seal against a grease nipple, the seat having a bore through which grease from the nipple may pass.

14. The tool of claim 3, wherein:
the button bolt has a head that is retained by and reciprocates within the insert.

15. The tool of claim 3, wherein:
the grease coupling is associated with a reciprocating, retractable safety shroud.

16. The tool of claim 15, wherein:
the safety shroud is carried by the tube.

17. The tool of claim 8, wherein:
the grease coupling further comprises an internal seat adapted to seal against a grease nipple, the seat having a bore through which grease from the nipple may pass.

18. The tool of claim 8, wherein:
the button bolt has a head that is retained by and reciprocates within the insert.

19. The tool of claim 8, wherein:
the grease coupling is associated with a reciprocating, retractable safety shroud.

20. The tool of claim 19, wherein:
the safety shroud is carried by the tube.
